(19) United States
(12) Patent Application Publication
(10) Pub. No.: US 2020/0404927 A1
(43) Pub. Date: Dec. 31, 2020

(54) SEED, SOIL, AND PLANT TREATMENT COMPOSITIONS INCLUDING YEAST EXTRACT

(71) Applicant: RALCO NUTRITION, INC., Marshall, MN (US)

(72) Inventors: Richard LAMB, Balaton, MN (US); Rachel RATHS, Marshall, MN (US)

(21) Appl. No.: 16/977,071

(22) PCT Filed: Feb. 26, 2019
(86) PCT No.: PCT/US2019/019515

§ 371 Date: Aug. 31, 2020

Related U.S. Application Data
(60) Provisional application No. 62/637,104, filed on Mar. 1, 2018.

(51) Int. Cl. A01N 63/32; A01N 59/26; A01N 59/14; A01N 59/16; A01N 59/02; A01N 59/10; C05D 9/02

(52) U.S. Cl. CPC A01N 63/32; A01N 59/26; A01N 59/14; C05D 9/02; A01N 59/02; A01N 59/10; A01N 59/16

(57) ABSTRACT

Embodiments of the present disclosure describe a seed, soil, or plant treatment composition comprising yeast extract. Embodiments of the present disclosure describe methods of making a treatment composition comprising contacting yeast extract and a solvent to form a solution, adding one or more chemical species to the solution, and mixing the solution to form the seed, soil, or plant treatment composition. Embodiments of the present disclosure describe a method of treating seeds, soil, or a plant comprising applying a treatment composition to one or more of seeds, soil, and a plant, wherein the treatment composition includes yeast extract.

### BACKGROUND

Trace minerals have been found to facilitate the growth, yield, and health of agricultural crops. Such trace minerals may include chlorine, iron, boron, manganese, zinc, copper, molybdenum, sodium, silicon, nickel, and cobalt. In addition, organic carbon, amino acids, vitamins, and other components can have a beneficial impact on plant growth and health, as well as enrich the soil by providing a food source to the microorganisms present therein. However, formulating compositions that include such components has proven challenging and the subject of extensive research.

Accordingly, it is therefore desirable to formulate an improved plant treatment composition that further enhances plant performance by supplying one or more of these components.

### SUMMARY

In general, embodiments of the present disclosure describe seed, soil, and/or plant treatment compositions.

Embodiments of the present disclosure describe seed, soil, or plant treatment compositions comprising yeast extract.

Embodiments of the present disclosure describe methods of making a treatment composition comprising contacting yeast extract and a solvent to form a solution, adding one or more chemical species to the solution, and mixing the solution to form the seed, soil, or plant treatment composition.

Embodiments of the present disclosure describe methods of treating seeds, soil, or a plant comprising applying a treatment composition to one or more seeds, soil, and a plant, wherein the treatment composition includes yeast extract.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a treatment composition, according to one or more embodiments of the present disclosure.

FIG. 2 is a flowchart of a method of using a seed, soil, or treatment composition in-furrow, according to one or more embodiments of the present disclosure.

FIG. 3 is a flowchart of a method of using a treatment composition including yeast extract in-furrow, according to one or more embodiments of the present disclosure.

FIG. 4 is a flowchart of a method of using a treatment composition in pre-treatment of seeds, according to one or more embodiments of the present disclosure.

FIG. 5 is a flowchart of a method of using a treatment composition including yeast extract in pre-treatment of seeds, according to one or more embodiments of the present disclosure.

FIG. 6 is a flowchart of a method of using a treatment composition and inorganic fertilizer mixture, according to one or more embodiments of the present disclosure.

FIG. 7 is a flowchart of a method of using a treatment composition including yeast extract and inorganic fertilizer mixture, according to one or more embodiments of the present disclosure.

FIG. 8 is a flowchart of a method of using a treatment composition and herbicide mixture, according to one or more embodiments of the present disclosure.

FIG. 9 is a flowchart of a method of using a treatment composition including yeast extract and herbicide mixture, according to one or more embodiments of the present disclosure.

FIG. 10 is a flowchart of using a treatment composition and insecticide mixture, according to one or more embodiments of the present disclosure.

FIG. 11 is a flowchart of a method of using a treatment composition including yeast extract and insecticide mixture, according to one or more embodiments of the present disclosure.

FIG. 12 is a flowchart of a method of using a treatment composition and biological fertilizer, according to one or more embodiments of the present disclosure.

FIG. 13 is a flowchart of a method of using a treatment composition including yeast extract and biological fertilizer, according to one or more embodiments of the present disclosure.

FIG. 14 is a graphical view of average soybean seed weight per pot in trials where the treatment composition was applied as a seed treatment, according to one or more embodiments of the present disclosure.

FIG. 15 is a graphical view of average soybean seed weight per pot in trials where the treatment composition was applied as a seed treatment and in-furrow, according to one or more embodiments of the present disclosure.

FIG. 16 is a graphical view of showing soybean yield in trials where the treatment composition was applied foliar, according to one or more embodiments of the present disclosure.

FIG. 17 is a graphical view of V4 plant heat for each of the treatments applied to corn, according to one or more embodiments of the present disclosure.

FIG. 18 is a graphical view of corn biomass in trials where the treatment composition was applied as a seed treatment, according to one or more embodiments of the present disclosure.

FIG. 19 is a graphical view of corn biomass in trials where the treatment composition was applied in-furrow, according to one or more embodiments of the present disclosure.

FIG. 20 is a graphical view of corn biomass in trials where the treatment composition was applied foliar, according to one or more embodiments of the present disclosure.

FIGS. 21-22 are graphical views showing the percent change from check for corn (FIG. 21) and soy (FIG. 22) for seed treatments, in-furrow, and foliar applications, according to one or more embodiments of the present disclosure.

### DETAILED DESCRIPTION

The invention of the present disclosure relates to seed, soil, and plant treatment compositions. In particular, the invention of the present disclosure relates to seed, soil, and plant treatment compositions comprising yeast extract. The seed, soil, and plant treatment compositions may further be prepared from and/or include additional components, including, but not limited to, one or more of a mineral chelated compound, a mineral salt compound, a carrier, a solid carrier, a fiber, an enzyme, a pesticide, an insecticide, a fungicide, and a herbicide. The seed, soil, and plant treatment compositions can be applied alone or in combination with other components. In particular, the seed, soil, and plant treatment compositions of the present disclosure may be used as a seed treatment (e.g., as a seed pre-treatment), placed in-furrow, side-dressed in a field, used as a foliar treatment, broadcast on soil, tilled in soil, and/or mixed with fertilizers or chemicals to improve one or more of plant emergence, crop yield, stand count, leaf area, root size, plant height, plant health, and plant resistance to disease and drought. The treatment compositions of the present disclosure may be applied to any seed, soil, or plant. In some embodiments, the treatment compositions are applied to one or more of soy, corn, and wheat.

### DEFINITIONS

The terms recited below have been defined as described below. All other terms and phrases in this disclosure shall be construed according to their ordinary meaning as understood by one of skill in the art.

The term “chelation” refers to the formation of two or more separate coordinate bonds between a polydentate (multiple bonded) ligand and a single central atom, typically a metal ion. The ligands are typically organic compounds, often in anionic form, and can be referred to as chelants, chelators, or sequestering agents. A ligand forms a chelate complex with a substrate such as a metal ion. While chelate complexes typically form from polydentate ligands, as used herein the term chelate also refers to coordination complexes formed from monodentate ligands and a central atom. Mineral chelated compositions include chelation.

A “carboxylic acid” refers to organic acids characterized by the presence of a carboxyl group, which has the formula —C(═O)OH, often written —COOH or —CO₂H. Examples of carboxylic acids include lactic acid, acetic acid, EDTA, propionic acid and butyric acid.

A “fatty acid” refers to a carboxylic acid, often with a long unbranched aliphatic tail (chain), which may be either saturated or unsaturated. Short chain fatty acids typically have aliphatic tails of six or fewer carbon atoms. Examples of short chain fatty acids include lactic acid, propionic acid and butyric acid. Medium chain fatty acids typically have aliphatic tails of 6-12 carbon atoms. Examples of medium chain fatty acids include caprylic acid, capric acid and lauric acid. Long chain fatty acids typically have aliphatic tails of greater than 12 carbon atoms. Examples of ling chain fatty acids include myristic acid, palmitic acid and stearic acid. A fatty acid having only one carboxylic acid group can be a ligand of a mineral.

The term “lactic acid” refers to a carboxylic acid having the chemical structural formula of CH₃CH(OH)CO₂H. Lactic acid forms highly soluble chelates with many important minerals.

As used herein, an “inorganic mineral compound” or “mineral” refers to an elemental or compound composition including one or more inorganic species. For example, an inorganic mineral compound may be cobalt, cobalt carbonate, zinc oxide, cupric oxide, manganese oxide or a combination thereof. Inorganic mineral compounds may also include scandium, selenium, titanium, vanadium, chromium, manganese, iron, nickel, copper and zinc, for example. Transition metals can also be included and salts, oxides, hydroxides and carbonates of the above-mentioned compounds can be suitable inorganic mineral compounds.

As used herein, “mineral chelated compound” refers to chemical compound or mixture including at least one inorganic substance and a derivative of a carboxylic acid, or reaction product of a carboxylic acid and an inorganic mineral compound. Examples of mineral chelated compounds include but are not limited to cobalt, scandium, selenium, titanium, vanadium, chromium, manganese, iron, nickel, copper, zinc, or a combination thereof chelated to one or more ligands to form a chelate (a chelate complex or coordinate complex). Examples of suitable ligands include lactate, acetate, propionate, butyrate, ethylene diamine, and EDTA.

As used herein, an “inorganic fertilizer” refers to a composition intended to enhance the growth of plants by providing macronutrients such as one or more of nitrogen, potassium, phosphorus, calcium, magnesium, and sulfur. The inorganic fertilizer typically does not include significant amounts of living organisms. Inorganic fertilizers often include micronutrients, such as boron, chlorine, copper, iron, manganese, molybdenum and zinc. Inorganic fertilizers can also include optional ingredients such as greensand or rock phosphate. The inorganic fertilizer can be, for example, an NPK fertilizer, a known commercial fertilizer, or the like.

As used herein, “biological fertilizer”, “natural fertilizer” or “organic fertilizer” refers to a fertilizer that includes living organisms, or plant or animal matter. A biological fertilizer can include components such as manure, blood meal, alfalfa meal, seaweed, or compost. The fertilizers can be provided in a variety of granular or liquid forms.

As used herein, “pesticide” refers to a composition or product that kills or repels plant or seed pests, and may be broken into a number of particular sub-groups including, but not limited to, acaricides, avicides, bactericides, fungicides, herbicides, insecticides, miticides, molluscicides, nematicides, piscicides, predacides, rodenticides, and silvicides. Pesticides may also include chemicals which are not normally used as pest control agents, such as plant growth regulators, defoliants, and desiccants, or which are not directly toxic to pests, such as attractants and repellants. Some microbial pesticides may be bacteria, viruses, and fungi that cause disease in given species of pests. Pesticides may be organic or inorganic. Pesticides applied to plant seeds may remain on the surface of the seed coat following application, or may absorb into the seed and translocate throughout the plant.

As used herein, “herbicide” refers to a composition or product that kills or deters weed growth. One example of an herbicide includes glyphosate (i.e., RoundUp® herbicide).

As used herein, “insecticide” refers to a composition or product that kills or repels insects. Examples of insecticides include Sevin (carbaryl), permethrin, and Bacillus thruingiensis.

As used herein, “foliar” refers to the foliage of a plant or crop, or applying to the foliage of a plant or crop.

As used herein, “in-furrow” refers to applying a substance within a planting furrow in contact with or in near proximity to a seed. In-furrow application can occur before a seed is planted, simultaneous with seed planting, or after seed planting.

As used herein, “genetically modified plant” or “genetically modified organism” refers to an organism whose genetic material has been altered using genetic engineering techniques such as recombinant DNA technology.

As used herein, “rapidly soluble mineral chelated product” refers to a mineral chelated compound that has been altered to increase solubility in a solvent. Altering may include reducing in size, filtering, screening or chemically reacting. An inorganic mineral compound may be organically chelated such that its solubility changes from insoluble to soluble in a chosen solvent.

As used herein, “solution” refers to a homogeneous or substantially homogeneous mixture of two or more substances, which may be solids, liquids, gases or a combination thereof.

As used herein, “mixture” refers to a combination of two or more substances in physical or chemical contact with one another.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “adding” refers to bringing into contact two or more components. In many embodiments, “adding” refers to “contacting,” as that term is defined above.

As used herein, “mixing” refers to one or more of mixing, stirring, agitating, vibrating, shaking, turning, spinning, and/or other conventional techniques known in the art to facilitate and/or achieve contacting, as that term is defined above.

As used herein, “applying” refers to bringing one or more components into nearness or contact with another component. Applying can refer to contacting or administering.

As used herein, “pre-treatment” or “seed treatment” refers to chemically and/or physically contacting seeds with a composition prior to planting.

As used herein, “reacting” refers to undergoing a chemical change. Reacting may include a change or transformation in which a substance oxidizes, reduces, decomposes, combines with other substances, or interchanges constituents with other substances.

As used herein, “transferring” refers to moving a component or substance from one place or location to another.

As used herein, “mold” refers to a hollow form or matrix for shaping a fluid, gel, semi-solid or plastic substance.

As used herein, “filtering” or “filtration” refers to a mechanical method to separate solids from liquids, or separate components by size or shape. This can be accomplished by gravity, pressure or vacuum (suction).

As used herein, “carrier” refers to a substance that physically or chemically binds or combines with a target or active substance to facilitate the use, storage or application of the target or active substance. Carriers are often inert materials, but can also include non-inert materials when compatible with the target or active substances. Examples of carriers include, but are not limited to, water for compositions that benefit from a liquid carrier, or diatomaceous earth for compositions that benefit from a solid carrier.

As used herein, “substrate” refers to a base layer or material on which an active or target material interacts with, is applied to, or acts upon.

As used herein, “stoichiometric” or “stoichiometric amounts” refer to starting materials of a reaction having molar amounts or substantially molar amounts such that the reaction product is formed with little to no unused starting material or waste. A stoichiometric reaction is one in which all starting materials are consumed (or substantially consumed) and converted to a reaction product or products.

As used herein, “adherent” refers to a material, such as a polymer, that facilitates contact or binding of one or more chemicals with a seed during a seed-pre-treatment process.

As used herein, “enzymes” refers to one or more biological molecules capable of breaking down cellulosic material.

As used herein, “treatment compositions” refers to a seed, soil, and/or plant treatment composition as described herein.

As used herein, “nickel-iron-molybdenum treatment composition” refers to a treatment composition including, but not limited to, one or more nickel compounds, one or more iron compounds, and one or more molybdenum compounds. In many embodiments, additional components and/or compounds may be further included in the nickel-iron-molybdenum treatment compositions.

Embodiments of the present disclosure describe a seed, soil, or plant treatment composition comprising yeast extract. In many embodiments, the seed, soil, or plant treatment composition may further comprise one or more mineral chelated compounds and/or one or more mineral salts. In some embodiments, the seed, soil, or plant treatment composition may further comprise one or more a carrier, a solid carrier, a fiber, an enzyme, a pesticide, an insecticide, a fungicide, and an herbicide.

The yeast extract may include yeast cells without cell walls or substantially without cell walls. Yeast extracts without cell walls or substantially without cell walls may be water soluble or substantially water soluble. In many embodiments, yeast extract includes one or more of the components of a yeast cell, without a cell wall or substantially without a cell wall. The yeast extract may be derived from one or more yeast cells. For example, the yeast extract may be derived from a plurality of yeast cells of one or more genera or species of yeast. Examples of yeast cells include, but are not limited to, those belonging to the genera: Metschnikowia, Aureobasidiuim, Cryptococcus, Candida, Hanseniaspora, Pichia, Sporobolomyces, Sporidiobolus, Bulgaria, Cystofilobasidium, Malassezia, Saccharomyces, Rhodotorula, Mrakia, Glaciozyma, Starmerella, Wickerhamomyces, Tilletiopsis, Galactomyces, Issatchenkia, Kluyveromyces, Bensingtonia, Derxomyces, Hannaella, Dioszegia, Debaryomyces, Torulaspora, Trichosporon, Arthroderma, Hortaea, Rhodosporidium, Dipodascopsis, Kazachstania, and Kockovaella. Examples of species of yeast cells include, but are not limited to, one or more of Saccharomyces cerevisiae, Saccharomyces chevaiieri, Saccharomyces delbrueckii, Saccharomyces exiguus, Saccharomyces fermentati, Saccharomyces logos, Saccharomyces mellis, Saccharomyces microellipsoides, Saccharomyces oviformis, Saccharomyces rosei, Saccharomyces rouxii, Saccharomyces sake, Saccharomyces uvarum Beij'er, Saccharomyces willianus, Saccharomyces sp., Saccharomyces ludwigii, Saccharomyces sinenses, Saccharomyces bailii, Saccharomyces carlsbergensis, Schizosaccharomyces octosporus, Schizosaccharomyces pombe, Sporobolomyces roseus, Sporobolomyces salmonicolor, Torulopsis Candida, Torulopsis famta, Torulopsis globosa, Torulopsis inconspicua, Trichosporon behrendoo, Trichosporon capitatum, Trichosporon cutaneum, Wickerhamia fluoresens, Ashbya gossypii, Blastomyces dermatitidis, Candida albicans, Candida arborea, Candida guillermondii, Candida Krusei, Candida lambxca, Candida lipolytica, Candida par akrusei, Candida par apsilosis, Candida par apsilosis, Candida pseudotropicalis, Candida pulcherrima, Candida robusta, Candida rugousa, Candida utilis, Citeromyces matritensis, Crebrothecium ashbyii, Cryptococcus laurentii, Cryptococcus neoformans, Debaryomyces hansenii, Debaryomyces kloeckeri, Endomycopsis fibuligera, Eremothecium ashbyii, Geotrichum candidum, Geotrichum ludwigii, Geotrichum robustum, Geotrichum suaveolens, Hansenula anomala, Hansenula arabitolgens, Hansenula jadinii, Hansenula saturnus, Hansenula schneggii, Hansenula subpelliculosa, Kloeckera apiculata, Lipomyces starkeyi, Pichia far inosa, Pichia membranaefaciens, Rhodosporidium toruloides, Rhodotorula aurantiaca, Rhodotorula glutinis, Rhodotorula minuta, Rhodotorula rubar, and Rhodotorula sinesis. The yeast extract may be derived from any of the above-mentioned yeast cells and any other yeast cells known in the art, wherein a cell wall of the yeast cells is removed or substantially removed sufficient to form the yeast extract.

The yeast extract may include or be combined with one or more vitamins and one or more cofactors. A cofactor may include a metal ion cofactor, a coenzyme, and/or a coenzyme precursor. In an embodiment, the yeast extract may include a mixture of one or more of amino acids, peptides, water-soluble vitamins, and carbohydrates. For example, in some embodiments, the yeast extract may include compounds of one or more of thiamin, riboflavin, niacin, biotin, vitamin B6, folic acid, panthenol, pantothenic acid, inositol, cyanocobalamin, citric acid, pyridoxine, calcium, copper, iron, magnesium, manganese, phosphorous, potassium, sodium, and zinc. In embodiments in which the yeast extract includes or is combined with one or more vitamins and one or more cofactors, the yeast extract may be referred to as vitamin-enriched yeast extract. For example, in an embodiment, the yeast extract is a vitamin-enriched yeast extract.

The listed vitamins and cofactors can be provided in the composition in any form including vitamin derivatives and provitamin forms. Optionally, one or more alcohols can be utilized in the composition to enhance the activity and aid in the preservation of one or more vitamins In an embodiment, an alcohol that may be utilized is benzyl alcohol.

The thiamine compounds may include one or more of thiamine hydrochloride, thiamine pyrophosphate, thiamine monophosphate, thiamine disulfide, thiamine mononitrate, thiamine phosphoric acid ester chloride, thiamine phosphoric acid ester phosphate salt, thiamine 1,5 salt, thiamine triphosphoric acid ester, and thiamine triphosphoric acid salt.

The riboflavin compounds may include one or more of riboflavin, riboflavin acetyl phosphate, flavin adenine dinucleotide, flavin adenine mononucleotide, and riboflavin phosphate.

The niacin compounds may include one or more of niacinamide, nicotinic acid, nicotinic acid adenine dinucleotide, nicotinic acid amide, nicotinic acid benzyl ester, nicotinic acid monoethanolamine salt, nicotinic acid hydrazide, nicotinic acid hydroxyamate, nicotinic acid-N-(hydroxymethyl) amide, nicotinic acid methyl ester, nicotinic acid mononucleotide, and nicotinic acid nitrite.

The pyridoxine compounds may include one or more of pyridoxine hydrochloride, and pyridoxal phosphate. Suitable forms of folic acid compounds may include one or more of folic acid and folinic acid.

The biotin compounds may include one or more of biotin, biotin sulfoxide, yeast, yeast extract, biotin 4-amidobenzoic acid, biotin amidocaproate N-hydroxysuccinimide ester, biotinyl 6-aminoquinoline, biotin hydrazide, biotin methyl ester, d-biotin-N-hydroxysuccinimide ester, biotin-maleimide, d-biotin p-nitrophenyl ester, biotin propranolol, 5-(N-biotinyl)-3-aminoallyl)-uridine 5′-triphosphate, biotinylated urdidine 5′-triphosphate, and N-e-biotinyl-lysine.

The panthothenic acid compounds may include one or more of coenzyme A.

In an embodiment, the yeast extract can include one or more of sulfur, phosphorus, potassium, magnesium, calcium sodium, iron, manganese, copper, zinc, aspartic acid, threonine, serine, glutamic acid, proline, glycine, alanine, cysteine, valine, methionine, isoleucine, leucine, tyrosine, phenylalanine, lysine, histidine, arginine, tryptophan, nitrogen, and organic carbon. In an embodiment, the yeast extract can include

A yeast extract content of the treatment composition may range from about 0.1 wt. % to about 10.0 wt. %. In embodiments in which the treatment composition is used as a seed treatment, the yeast extract content of the seed treatment composition may range from about 0.5 wt. % to about 5.0 wt. %. In a preferred embodiment, the yeast extract content is about 2.0 wt. %. In embodiments in which the treatment composition is used in applications other than seed treatment applications, the yeast extract content of the treatment composition may range from about 1.0 wt. % to about 50 wt. %. In a preferred embodiment, the yeast extract content is about 20 wt. %.

The seed, soil, or plant treatment compositions may further comprise chitosan. For example, in an embodiment, the seed, soil, or plant treatment composition comprises yeast extract and chitosan. In these embodiments, the seed, soil, or plant treatment compositions may further comprise one or more of mineral chelated compounds, mineral salt compounds, a carrier, a solid carrier, a fiber, an enzyme, a pesticide, an insecticide, a fungicide, and a herbicide.

The seed, soil, or plant treatment compositions may further comprise one or more mineral chelated compounds. A mineral of the mineral chelated compound may include one or more of cobalt, scandium, selenium, titanium, vanadium, manganese, iron, nickel, copper, and zinc. For example, the mineral chelated compound may include one or more of a cobalt chelated compound, a scandium chelated compound, a selenium chelated compound, a titanium chelated compound, a vanadium chelated compound, a manganese chelated compound, an iron chelated compound, a nickel chelated compound, a copper chelated compound, and a zinc chelated compound.

A chelate of the mineral chelated compound may include one or more of lactate, ethylene diamine, ethylenediamine tetraacetate (EDTA), propionate, butyrate, and acetate. For example, the mineral chelated compound may include one or more of a mineral lactate compound, a mineral ethylene diamine compound, a mineral ethylenediamine tetraacetate compound, a mineral propionate compound, a mineral butyrate compound, and a mineral acetate compound.

The seed, soil, or plant treatment composition may further comprise one or more mineral salt compounds. A mineral of the mineral salt may include one or more of cobalt, scandium, selenium, titanium, vanadium, manganese, iron, nickel, copper, zinc, aluminum, tin, and chromium. For example, the mineral salt may include one or more of a cobalt salt compound, a scandium salt compound, a selenium salt compound, a titanium salt compound, a vanadium salt compound, a manganese salt compound, an iron salt compound, a nickel salt compound, a copper salt compound, a zinc salt compound, an aluminum salt compound, a tin salt compound, and a chromium salt compound.

A salt anion of the mineral salt compound may include one or more of bromide, chloride, fluoride, carbonate, hydroxide, nitrate, oxide, phosphate, sulfate, formate, acetate, propionate, butyrate, oxalate, citrate, malate, lactate, or tartrate. For example, the mineral salt compound may include one or more of a mineral bromide compound, a mineral chloride compound, a mineral fluoride compound, a mineral carbonate compound, a mineral hydroxide compound, a mineral nitrate compound, a mineral oxide compound, a mineral phosphate compound, a mineral sulfate compound, a mineral formate compound, a mineral acetate compound, a mineral propionate compound, a mineral butyrate compound, a mineral oxalate compound, a mineral citrate compound, a mineral malate compound, a mineral lactate compound, and a mineral tartrate compound.

In some embodiments, the seed, soil, or plant treatment composition comprises yeast extract and one or more mineral chelated compounds and one or more mineral salt compounds.

In some embodiments, the seed, soil, or plant treatment composition comprises yeast extract and at least one additional mineral, wherein the at least one additional mineral is present as both a mineral salt and a mineral chelate. For example, in an embodiment, the seed, soil, or plant treatment composition comprises yeast extract and at least one additional mineral, wherein the at least one additional mineral is a cobalt. The cobalt may be present a cobalt salt and a cobalt chelate. The cobalt may include a cobalt compound. The cobalt compound may include one or more of cobalt lactate, cobalt carbonate, cobalt gluconate, cobalt sulfate, and cobalt oxides. In an embodiment, the cobalt chelate is cobalt lactate and the cobalt salt is cobalt sulfate. These shall not be limiting, as any suitable mineral, either present as a mineral salt, a mineral chelate, or both, may be used herein.

In an embodiment, the composition comprises yeast extract and one or more of a cobalt chelated compound, a scandium chelated compound, a selenium chelated compound, a titanium chelated compound, a vanadium chelated compound, a manganese chelated compound, an iron chelated compound, a nickel chelated compound, a copper chelated compound, and a zinc chelated compound, wherein a chelate includes one or more of lactate, ethylene diamine, ethylenediamine tetraacetate (EDTA), propionate, butyrate, and acetate.

In an embodiment, the composition comprises yeast extract and one or more of a mineral lactate compound, a mineral ethylene diamine compound, a mineral ethylenediamine tetraacetate compound, a mineral propionate compound, a mineral butyrate compound, and a mineral acetate compound, wherein a mineral includes one or more of cobalt, scandium, selenium, titanium, vanadium, manganese, iron, nickel, copper, and zinc.

In an embodiment, the composition comprises yeast extract and one or more of a cobalt salt compound, a scandium salt compound, a selenium salt compound, a titanium salt compound, a vanadium salt compound, a manganese salt compound, an iron salt compound, a nickel salt compound, a copper salt compound, a zinc salt compound, an aluminum salt compound, a tin salt compound, and a chromium salt compound, wherein a salt anion includes one or more of bromide, chloride, fluoride, carbonate, hydroxide, nitrate, oxide, phosphate, sulfate, formate, acetate, propionate, butyrate, oxalate, citrate, malate, lactate, or tartrate.

In an embodiment, the composition comprises yeast extract and one or more of a mineral bromide compound, a mineral chloride compound, a mineral fluoride compound, a mineral carbonate compound, a mineral hydroxide compound, a mineral nitrate compound, a mineral oxide compound, a mineral phosphate compound, a mineral sulfate compound, a mineral formate compound, a mineral acetate compound, a mineral propionate compound, a mineral butyrate compound, a mineral oxalate compound, a mineral citrate compound, a mineral malate compound, a mineral lactate compound, and a mineral tartrate compound, wherein a mineral includes one or more of cobalt, scandium, selenium, titanium, vanadium, manganese, iron, nickel, copper, zinc, aluminum, tin, and chromium.

In an embodiment, the composition comprises yeast extract and one or more of a mineral chelated compound and a mineral salt compound. Any of the mineral chelated compounds and mineral salt compounds of the present disclosure may be used herein. In a preferred embodiment, the composition comprises yeast extract and one or more of cobalt chelated compound. In a preferred embodiment, the composition comprises yeast extract and cobalt lactate. In any of these embodiments and any of the embodiments of the present disclosure, the composition may further comprise one or more of a mineral chelated compound and a mineral salt compound, among other things.

The compositions can be prepared using carriers. Carriers are ideally inert materials that do not react with the active components of the composition chemically, or bind the active components physically by absorption or adsorption. Liquid carriers may include pure water, such as reverse osmosis water, or other liquids, such as crop oils or surfactants which are compatible with the composition and plant tissue. The composition may be at least about 50% water by weight, at least about 65% water by weight, at least about 75% water by weight, at least about 85% water by weight, or at least about 90% water by weight. In some embodiments, the composition will be about 60% to about 70% water, 80% to about 99% water, about 85% to about 98% water, about 90% to about 95% water, or about 91% to about 94% water.

In some other compositions it is preferable to use solid carriers, such as diatomaceous earth, finely ground limestone (CaCO₃), or magnesium carbonate (MgCO₃). Sugars such as sucrose, maltose, maltodextrin, or dextrose may also be used as solid carriers. In other compositions, it is beneficial to use a combination of solid and liquid carriers.

The composition may also include a fiber, for example, a fiber that can act as a food source for beneficial bacteria in soil or another growth medium. Fiber can also act as an adherent. Soluble fibers are preferred as they generally enhance product efficacy and stability by keeping less soluble materials in solution or suspension due to their inherent charge and ability to disperse other charged components in solution. Soluble fibers also allow for higher composition-to-seed adhesion in pre-treatment. Fiber content within the composition is adjustable to better maintain less soluble materials in solution or suspension, and to modify composition “stickiness”. Higher fiber content and “stickiness” is often desirable in seed pre-treatments in order to ensure sufficient composition binding to and coverage of the seeds. Fiber content and type can also be modified to control composition-seed adhesion time, and adhesion strength. Because seeds can be pre-treated off-site and must be transported to farms, adhesion strength is important to ensure that pre-treatment compositions do not shake, rub, or fall off the seeds during processing, shipping, storage, or planting. The higher fiber content and overall concentration of pre-treatment compositions in comparison foliar and in-furrow application compositions may increase composition density. Lower fiber content may be preferable for liquid foliar or in-furrow application compositions, which ideally have lower percent solids and viscosities to allow for easier transport and application, and to minimize equipment clogging. Suitable and effective fibers include hemicellulose, for example, the hemicellulose extracted from Larch trees. Another example of a suitable fiber is a yucca plant extract, commercially available as Saponix 5000 or BioLiquid 5000.

The composition can further include one or more enzymes, including a blend of enzymes. The enzymes can serve to break down cellulosic material and other material, including stover left on a field after harvest. Useful and beneficial enzymes include enzymes which break down starch, such as amylases, enzymes which break down protein, such as proteases, enzymes which break down fats and lipids, such as lipases, and enzymes which break down cellulosic material, such as cellulases.

The composition can also include one or more compatible pesticides, such as glyphosate. The composition can include many different types of fungicides, which may contain active ingredients including but not limited to: chlorothalonil, copper hydroxide, copper sulfate, mancozeb, flowers of sulfur, cymoxanil, thiabendazole, captan, vinclozolin, maneb, metiram, thiram, ziram, iprodione, fosetyl-aluminum, azoxystrobin, and metalaxyl. The composition can include many different types of insecticides, which may contain active ingredients including but not limited to: aldicarb, acephate, chlorpyrifos, pyrethroids, malathion, carbaryl, sulfuryl fluoride, naled, dicrotophos, phosmet, phorate, diazinon, dimethoate, azinphos-methyl, endosulfan, imidacloprid, and permethrin. The composition can include many different types of herbicides, which may contain active ingredients including but not limited to: diuron, 2-methyl-4-chlorophenoxyacetic acid (MCPA), paraquat, dimethenamid, simazine, trifluralin, propanil, pendimenthalin, metolachlor-S, glyphosate, atrazine, acetochlor, “2,4-D”, methylchlorophenoxypropionic acid (MCPP), pendimethalin, dicamba, pelarganoc acid, triclopyr, monosodium methyl arsenate (MSMA), sethoxydim, quizalofop-P, primisulfuron, imazamox, cyanazine, bromoxylin, s-ethyl dipropylthiocarbamate (EPTC), glufosinate, norflurazon, clomazone, fomesafen, alachlor, diquat, and isoxaflutole.

In an embodiment, the treatment composition including yeast extract may further comprise at least a mineral chelated compound. In many embodiments, the mineral chelated compound is a cobalt chelated compound. The chelate of the cobalt chelated compound may include one or more of lactate, ethylene diamine, ethylenediamine tetraacetate (EDTA), propionate, butyrate, and acetate. In a preferred embodiment, the cobalt chelated compound is cobalt lactate. This shall not be limiting as any of the mineral chelated compounds of the present disclosure may be used herein.

In an embodiment, the treatment composition including yeast extract may further comprise a mineral chelated compound and a mineral salt compound, wherein the mineral of the mineral chelated compound and the mineral salt compound is the same. For example, in an embodiment, the mineral chelated compound may include a cobalt chelated compound and the mineral salt compound may include cobalt and a salt anion. The chelate of the cobalt chelated compound may include one or more of lactate, ethylene diamine, ethylenediamine tetraacetate (EDTA), propionate, butyrate, and acetate. The salt anion of the mineral salt compound may include one or more of bromide, chloride, fluoride, carbonate, hydroxide, nitrate, oxide, phosphate, sulfate, formate, acetate, propionate, butyrate, oxalate, citrate, malate, lactate, or tartrate. In a preferred embodiment, the mineral chelated compound is cobalt lactate and the mineral salt compound is cobalt sulfate. These shall not be limiting as any of the mineral chelated compounds and mineral salt compounds of the present disclosure may be used herein.

In an embodiment, the composition can be prepared with and/or combined with an in-furrow treatment composition. The in-furrow treatment composition may include yeast extract, a mineral chelated compound, and a mineral salt. For example, the mineral of the mineral chelated compound may include a mineral, such as one or more of cobalt, manganese, copper, and zinc. The chelate of the mineral chelated compound may include lactate and an anion of the mineral salt compound may include sulfate. In many embodiments, the in-furrow treatment composition may include one or more of yeast extract, cobalt lactate, cobalt sulfate, ferric ammonium citrate, manganese lactate, copper lactate, zinc sulfate, zinc lactate, an emulsifier, a surfactant (e.g., Saponix 5000), and a soluble fiber (e.g., liquid arabinogalactan).

In an embodiment, the composition is prepared to provide high percentages of aqueous soluble minerals. Additional components may optionally include forms of soluble calcium, boric acid, and the like.

In some embodiments, the composition includes a carrier, additional chelated or inorganic salts, soluble fiber, and enzymes. Some exemplary chelated or inorganic salts particular to this embodiment include salts of scandium, selenium, titanium, vanadium, chromium, manganese, iron, nickel, copper, zinc, molybdenum, or combinations thereof.

In some embodiments, the composition can contain up to 98% carrier, such as water, 0-40% of yeast extract, 0-60% of one or more exemplary chelated or inorganic salts, 0-15% fiber, and 0-0.1 enzymes. In some such embodiments the fiber can be soluble.

Another composition that can be used to treat seeds, plants, and soil is a dry mixture of components that can be applied as a powder to a desired target (e.g., seed, plants, or soil). Components that can be included in such a composition include yeast extract, dextrose, copper sulfate, manganese sulfate, zinc sulfate, yucca extract, hemicellulosic fiber, and enzymes capable of digesting cellulosic fiber.

Another composition that can be used to treat seeds, plants, and soil is a treatment composition that includes yeast extract and various other components such as fiber and enzymes. A treatment composition of the invention can be an aqueous solution or aqueous dispersion or suspension.

In one embodiment, a composition can include about 85% to about 95% water, yeast extract, nickel lactate and/or nickel sulfate, ferric ammonium citrate, ammonium molybdate or molybdic acid, cobalt lactate, iron-EDTA or iron lactate, manganese-EDTA or manganese lactate, copper sulfate or copper lactate, zinc sulfate or zinc lactate, soluble hemicellulosic fiber, and enzymes that can facilitate the degradation of cellulosic material.

The treatment compositions of the present disclosure provide flexibility and control over numerous applications. The treatment compositions including yeast extract may be combined, mixed, and/or contacted with any of the other components, including those disclosed herein and those not disclosed herein, to achieve the benefits of the treatment composition of the present disclosure in addition to the benefits provided by the other components (e.g., such as a fertilizer, pesticide, etc.). It may be desirable to vary the components to be combined, mixed, and/or contacted with the treatment composition of the present disclosure over time and/or over the course of a season. For example, some components may be more desirable early in a season and other components may be more desirable later in a season (e.g., before harvesting). In addition, the treatment compositions of the present disclosure may be combined with other components in either a liquid form and/or a solid form.

Many embodiments relate to compositions that can be used to treat seeds, plants, and soil include mixtures having natural, organic, inorganic, or biological fertilizers, or combinations thereof, with one or more compatible pesticides. These compositions may also contain enzymes, fibers, water, and minerals as discussed above. Such mixtures ensure or enhance seed germination and plant growth, health, and yield while protecting seeds and plants from infection or infestation and harsh conditions, such as drought. Seed pre-treatment has shown to be beneficial for a number of reasons. In general, seed pre-treatment will create a zone of pest suppression after planting in the immediate area of the seed. As a result, fewer pesticide application trips are required, which minimizes physical damage to plants, reduces application and handling costs, and cuts down on pesticide drift problems.

For some pests, such as fungal diseases, protectant seed treatments are preferable to post-infestation or post-infection treatments because the pathogens live in such close association with host plants that it can be difficult to kill the pest without harming the host. Other types of fungicidal seed pre-treatments include seed disinfestation, which controls spores and other forms of disease organisms on the seed surface, and seed disinfection, which eliminates pathogens that have penetrated into the living cells of the seed.

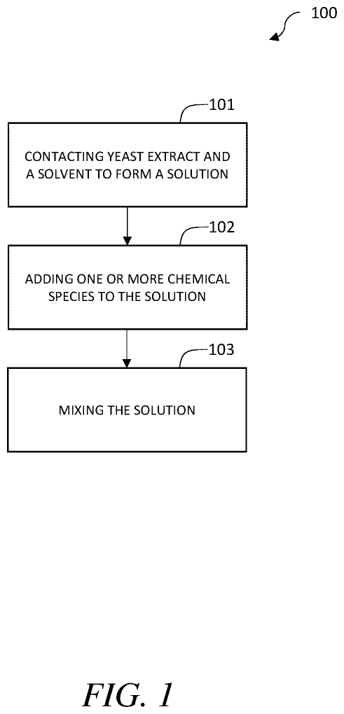

FIG. 1 is a flowchart of a method of making a treatment composition, according to one or more embodiments of the present disclosure. As shown in FIG. 1, the method comprises contacting 101 yeast extract and a solvent to form a solution, adding 102 one or more chemical species to the solution, and mixing 103 the solution to form the seed, soil, or plant treatment composition.

At step 101, yeast extract is contacted with a solvent to form a solution. Contacting may include any techniques known in the art for bringing two or more chemical species in any phase (e.g., solid, liquid, gas, or vapor) sufficient to make physical or chemical contact, or bring into immediate or close proximity. Any of the yeast extracts of the present disclosure may be used herein.

At step 102, one or more chemical species are added to the solution, Adding may include bringing into physical contact, or immediate or close proximity, such as contacting. The one or more chemical species may include one or more of mineral chelated compounds, mineral salt compounds, a carrier, a solid carrier, a fiber, an enzyme, a pesticide, an insecticide, a fungicide, and an herbicide. Any of the mineral chelated compounds, mineral salt compounds, carriers, solid carriers, fibers, enzymes, pesticides, insecticides, fungicides, and herbicides of the present disclosure may be used herein.

At step 103, the solution is mixed sufficient to form the treatment composition. Mixing may include stirring, agitating, vibrating, shaking, turning, spinning, and/or any other techniques known in the art. Although not shown, the method may further comprise optional steps relating to removing residual solvent and/or impurities, washing, and drying, among other techniques known in the art for isolating a product.

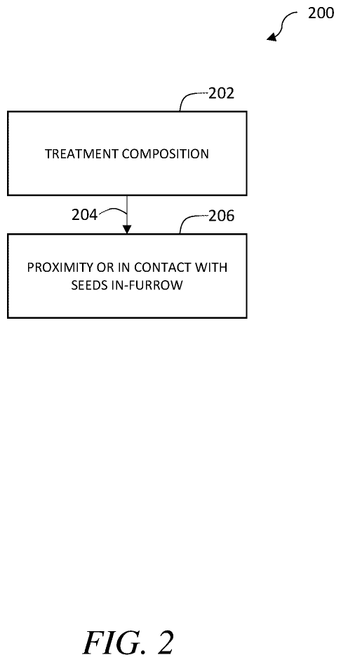

FIG. 2 is a flowchart of a method 200 of using a treatment composition in-furrow, according to one or more embodiments of the present disclosure. One or more treatment compositions 202 can be applied 204 in proximity or in-contact with one or more seeds in-furrow 206. In order to save a farmer time and increase efficiency, one or more treatment compositions 202 can be simultaneously or near-simultaneously placed in-furrow during planting. In-furrow fertilizers can be applied within proximity to a seed or in contact with a seed to promote more vigorous seedling growth by providing immediate nutrient supply to the plant roots. Proximity of in furrow fertilizer to seeds is determined based fertilizer compositions, such as ammonia and salt content that may be toxic to young seedlings. Soil type can also affect in-furrow fertilization efficacy as dryer, sandier soils can exacerbate root zone drying. Maintaining higher moisture content in soil can improve crop response to in-furrow fertilization by alleviating the effects of salt and ammonia. In addition to in-furrow, the treatment composition can be introduced in a side-dress application, tilled in soil as a soil surface application, and combinations thereof. A treatment composition including yeast extract is an example of a treatment composition that can be placed in-furrow with a plant seed without risk or harm or incompatibility with the seeds or proximate chemical treatments.

In-furrow application compositions can be solids, homogenous liquids, or heterogeneous slurries. Liquid or slurry application compositions may be preferable as they can be applied using common agricultural sprayers and other like equipment. In many embodiments, the treatment compositions are provided in liquid form.

The treatment composition includes yeast extract. The treatment composition can also include one or more enzymes, carriers, fiber, or a combination thereof. Examples of such compounds and methods of making are described in co-owned U.S. patent application Ser. No. 12/835,545. These treatment compositions may include any of the components and/or compounds described herein and thus shall not be limiting.

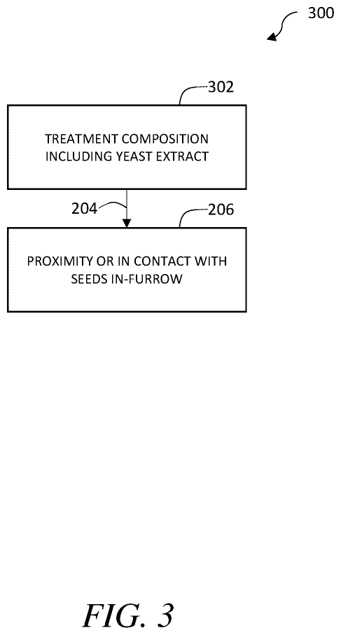

FIG. 3 is a flowchart of a method 300 of using a treatment composition including yeast extract in-furrow, according to one or more embodiments of the present disclosure. The treatment composition including yeast extract 302 can be applied 204 in proximity or in-contact with one or more seeds in-furrow 206.

Examples of treatment compositions 302 include treatment compositions including yeast extract. The yeast extract may be a vitamin-enriched yeast extract. The other components and/or compounds may include one or more of a a mineral chelated compound, a mineral salt compound, carrier, solid carrier, fiber, enzyme, pesticide, fungicide, insecticide, herbicide, and chelated or inorganic salts.

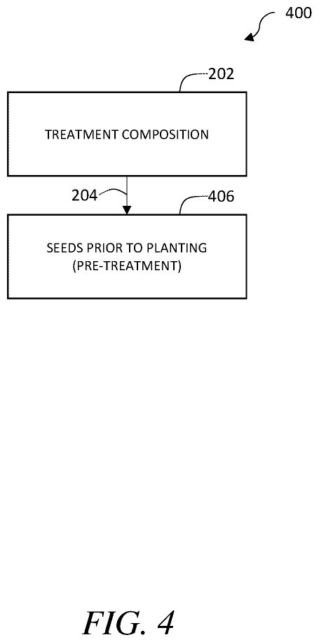

FIG. 4 is a flowchart of a method 400 of using a treatment composition in pre-treatment of seeds, according to one or more embodiments of the present disclosure. The treatment composition 202 can be applied 204 to one or more seeds prior to planting, such as in a pre-treatment stage 406.

Seed pre-treatment pesticides can be applied as dusts, but are often homogenous solutions or heterogenous slurries or suspensions. Seed treatment or pretreatment 406 can be accomplished within a seed bag or by mechanical means, such as in a tumbler. The one or more seeds can be agitated after applying 204. Agitating can include tumbling, vibrating, mixing, shaking, and combinations thereof. The applying 204 can be accomplished by spraying, pouring or other means of contacting the treatment composition and seeds. Applying 204 a treatment composition can be performed at an end amount of about 4-5 grams/acre, about 2-5 gms/a, about 5-35 gms/a, about 25-70 gms/a, about 45-95 gms/a, about 75-140 gms/a, about 100-500 gms/a or about 5-5000 gms/a, for example. Seed pre-treatment can be carried out at an off-site facility, on-site at the farm, or on-board planting equipment immediately prior to planting.

The treatment composition can be combined with one or more pesticides, including herbicides, insecticides, fungicides, and adherents, including commercial products, without negatively affecting the commercial product or seeds. The adherent can be a polymer (e.g., polysaccharide) such as a biocompatible and biodegradable adhesive material used in agricultural settings.

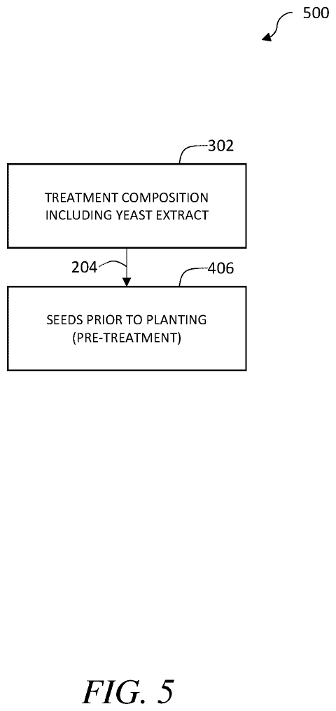

FIG. 5 is a flowchart of a method 500 of using a treatment composition including yeast extract in pre-treatment of seeds, according to one or more embodiments of the present disclosure. One or more treatment compositions including yeast extract 302 can be applied 204 to one or more seeds prior to planting, such as in a pre-treatment stage 406.

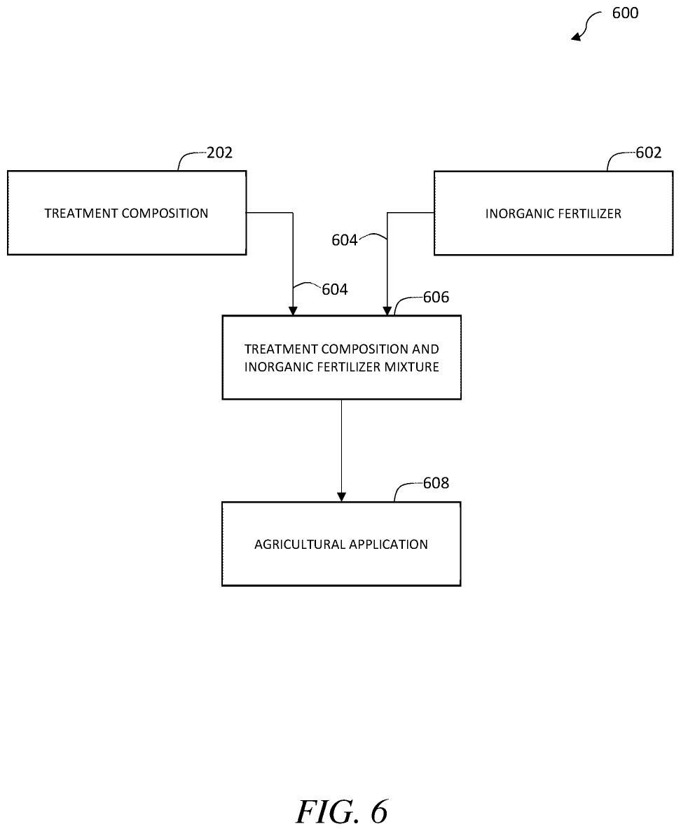

FIG. 6 is a flowchart of a method 600 of using a treatment composition and inorganic fertilizer mixture, according to one or more embodiments of the present disclosure. The treatment composition 202 can be contacted 604 or mixed with one or more inorganic fertilizers 602, sufficient to form a mixture 606. The mixture 606 can be used in an agricultural application 608. The applying the mixture in an agricultural application 608 can include one or more of applying to foliar, broadcasting on soil, tilling in soil, and in-furrow.

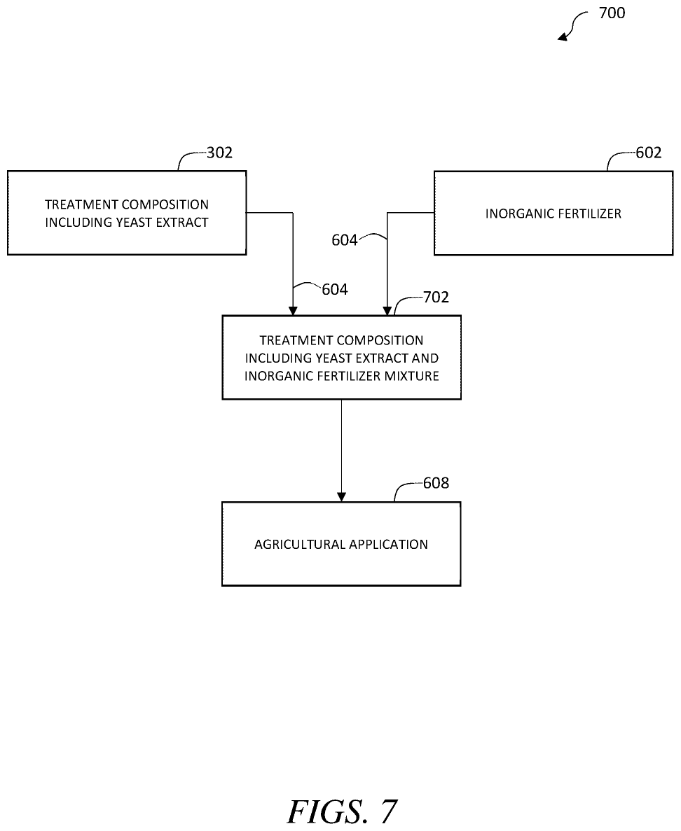

FIG. 7 is a flowchart of a method 700 of using a treatment composition including yeast extract and inorganic fertilizer mixture, according to one or more embodiments of the present disclosure. The treatment composition including yeast extract 302 can be contacted 605 or mixed with one or more inorganic fertilizers 602, sufficient to form a mixture 702. The mixture 702 can be used in an agricultural application 608.

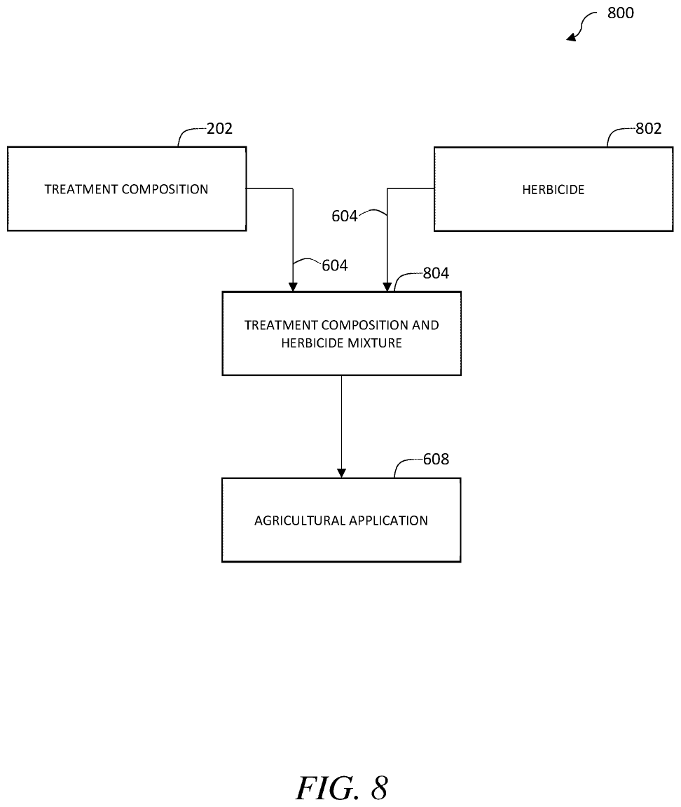

FIG. 8 is a flowchart of a method 800 of using a treatment composition and herbicide mixture, according to one or more embodiments of the present disclosure. The treatment composition 202 can be contacted 604 or mixed with one or more herbicides 802, sufficient to form a mixture 804. The mixture 804 can be used in an agricultural application.

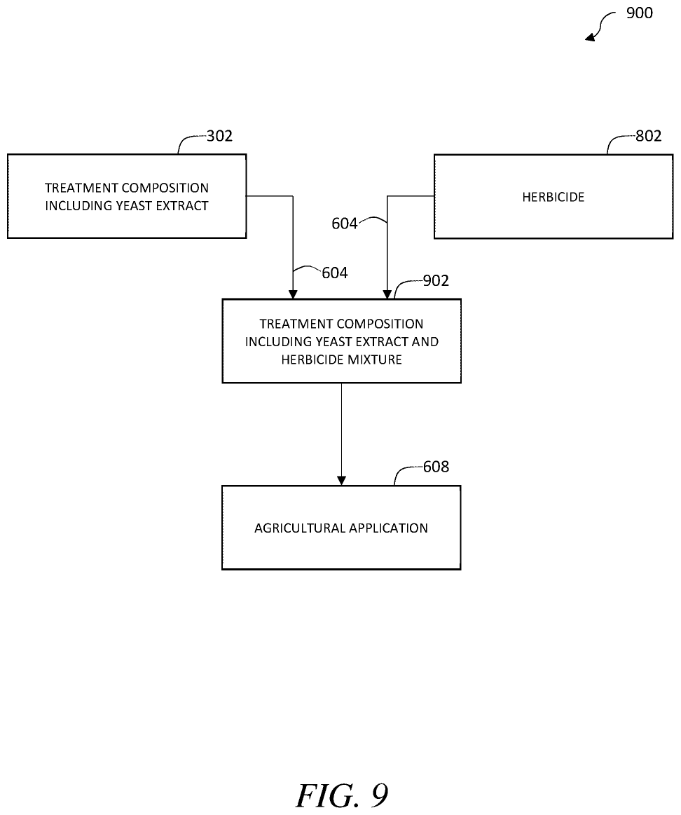

FIG. 9 is a flowchart of a method 900 of using a treatment composition including yeast extract and herbicide mixture, according to one or more embodiments of the present disclosure. The treatment composition including yeast extract 302 can be contacted 604 or mixed with one or more herbicides 802, sufficient to form a mixture 902. The mixture 902 can be used in an agricultural application.

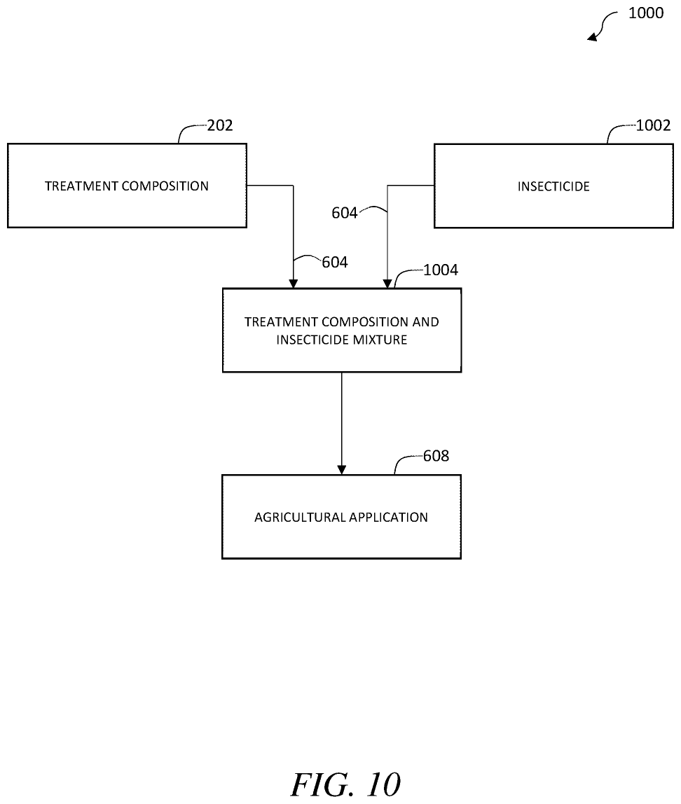

FIG. 10 is a flowchart of a method 1000 of using a treatment composition and insecticide mixture, according to one or more embodiments of the present disclosure. The treatment composition 202 can be contacted 604 or mixed with one or more insecticides 1002, sufficient to form a mixture 1004. The mixture 1004 can be used in an agricultural application 608.

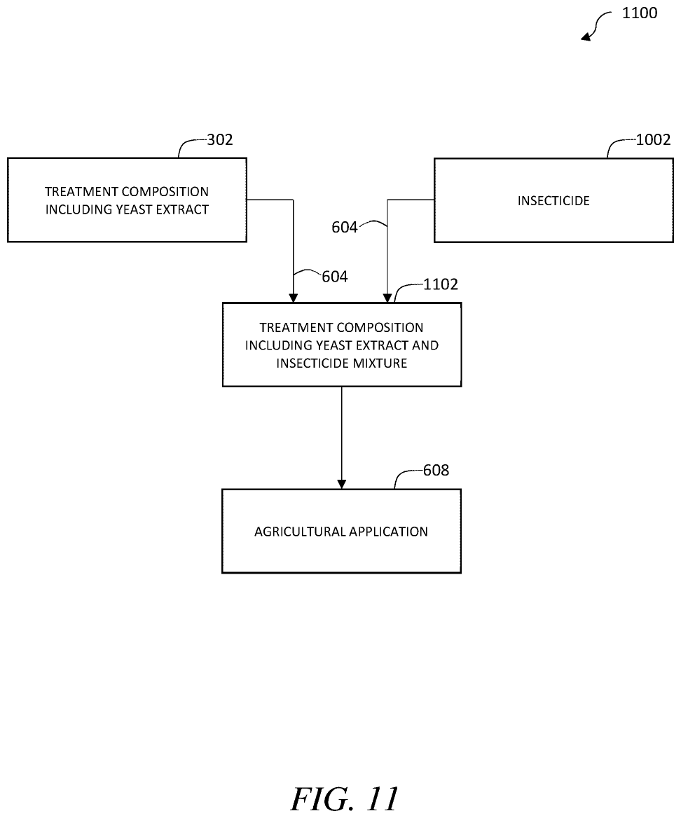

FIG. 11 is a flowchart of a method 1100 of using a treatment composition including yeast extract and insecticide mixture, according to one or more embodiments of the present disclosure. The treatment composition including yeast extract 302 can be contacted 604 with one or more insecticides 1002, sufficient to form a mixture 1102. The mixture 1102 can be used in an agricultural application 608.

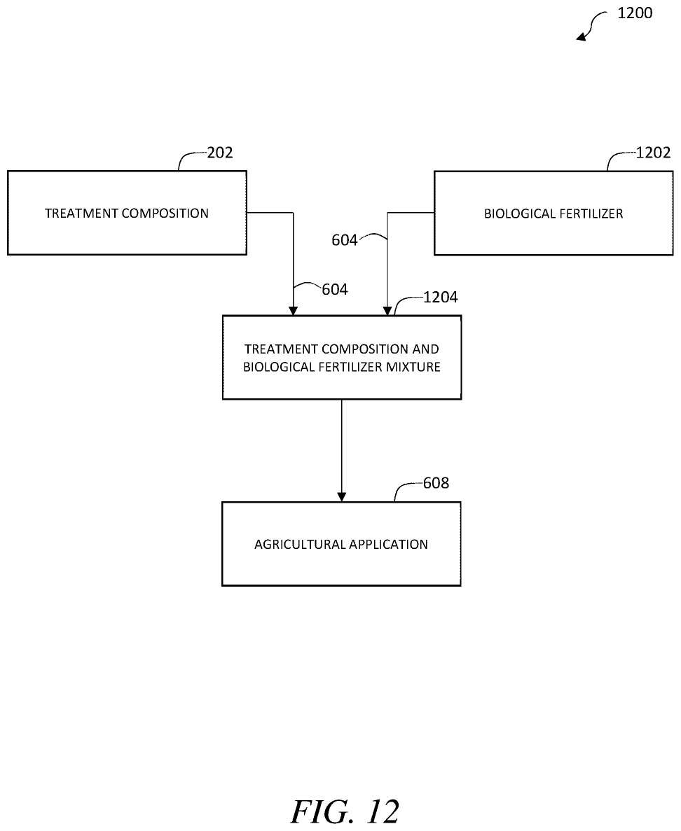

FIG. 12 is a flowchart of a method 1200 of using a treatment composition and biological fertilizer, according to one or more embodiments of the present disclosure. The treatment composition 202 can be contacted 604 or mixed with one or more biological fertilizers 1202, sufficient to form a mixture 1204. The mixture 1204 can be used in an agricultural application 608.

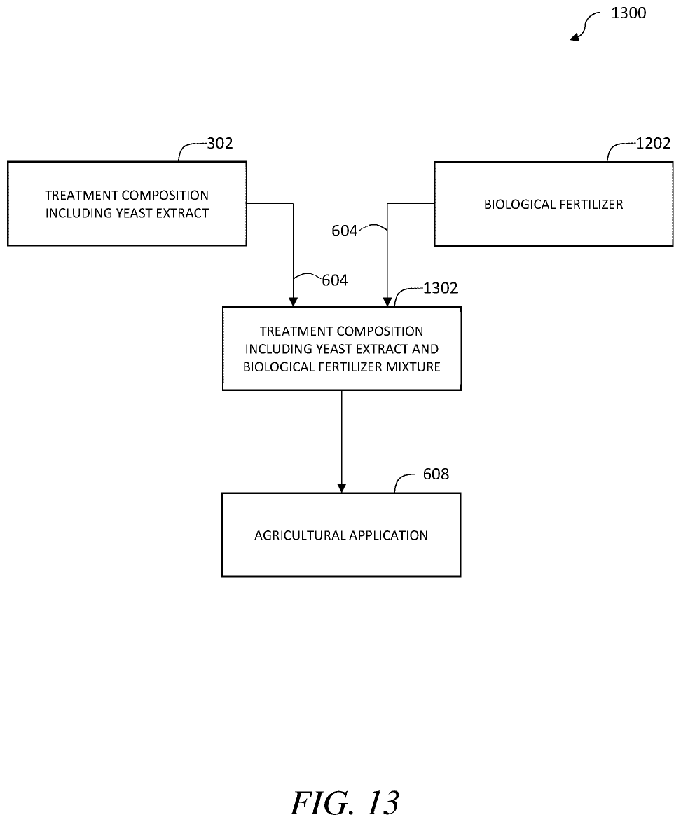

FIG. 13 is a flowchart of a method 1300 of using a treatment composition including yeast extract and biological fertilizer, according to one or more embodiments of the present disclosure. The treatment composition including yeast extract 302 can be contacted 604 or mixed with one or more biological fertilizers 1202, sufficient to form a mixture 1302. The mixture 1302 can be used in an agricultural application 608.

In some embodiments, a treatment method includes applying treatment compositions during multiple steps in a seed planting process. The treatment compositions can be applied to one or more seeds (e.g., a bag of seeds). The seeds are planted, and then the treatment compositions can optionally be re-applied in-furrow.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLES

### Yeast Extract Compositions Applied to Corn and Soy

The treatment compositions used herein comprised yeast extract without or substantially without cell walls. Trials were conducted in which the treatment compositions were applied to corn and soy on outside greenhouse tables and on research farms. The applications employed in the trials included seed treatment, in-furrow, and foliar applications. The yeast extracts used to prepare the treatment compositions were purchased from different commercial sources, including a powder form from Sigma Aldrich (product nos. 07533 and 70161) and a viscous by-product form referred to as ICC. Typically, the Sigma Aldrich product was dissolved in water to form a mixture and that mixture was applied at the rates described herein, whereas the ICC product was typically applied as-is (i.e., as viscous product without the addition of any water or other species) at the rates described herein, but there were some in-furrow and foliar applications of the ICC product that included the addition of water.

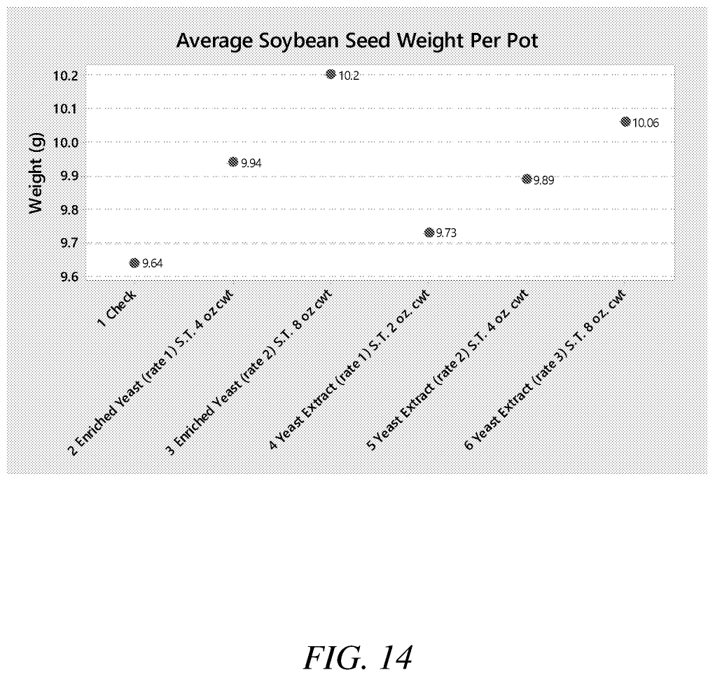

FIG. 14 is a graphical view of average soybean seed weight per pot in trials where the treatment composition was applied as a seed treatment, according to one or more embodiments of the present disclosure. The trials were planted and harvested about five months after planting. A total of 10 plants were individually monitored for each treatment. The treatments included (1) a check; (2) yeast extract (enriched with vitamins), Sigma Aldrich product number 07533 at 4 oz. cwt; (3) yeast extract (enriched with vitamins), Sigma Aldrich product number 07533 at 8 oz. cwt.; (4) yeast extract, Sigma Aldrich product number 70161 at 2 oz. cwt.; (5) yeast extract, Sigma Aldrich product number 70161 at 4 oz. cwt.; and (6) yeast extract, Sigma Aldrich product number 70161 at 8 oz. cwt. In treatments (2) through (6), the yeast extracts were dissolved in water and then applied to the seeds at the rates indicated above. A rate, such as 4 oz. cwt., means 4 oz. of product per 100 lbs. of seed. This is representative of the other application rates.

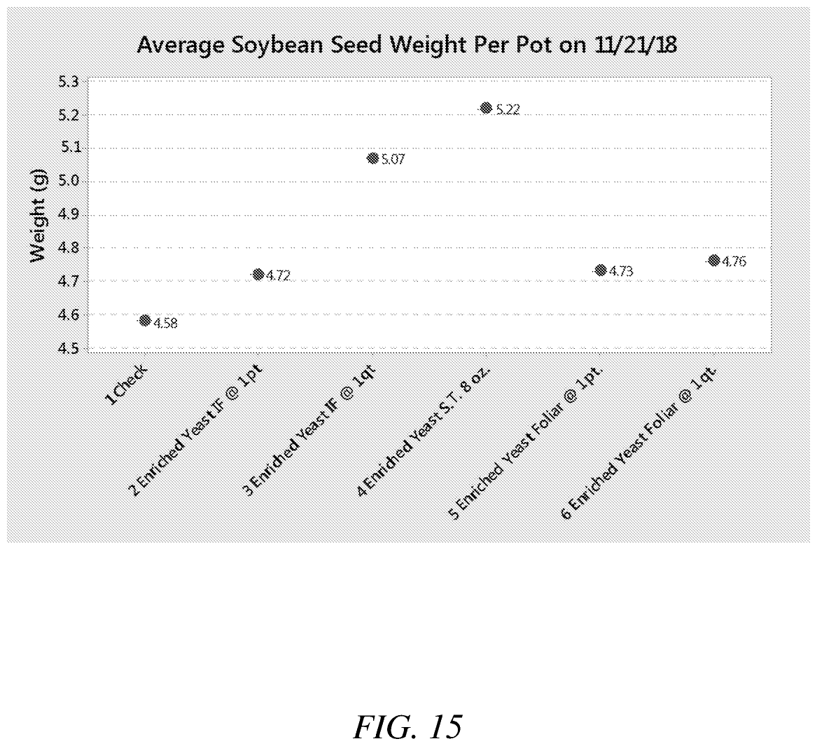

FIG. 15 is a graphical view of average soybean seed weight per pot in trials where the treatment composition was applied as a seed treatment and in-furrow, according to one or more embodiments of the present disclosure. The applications included seed treatments, as well as in-furrow and foliar applications to soy. In particular, the treatments included (1) a check; (2) enriched yeast (Sigma Aldrich product no. 07533) applied in-furrow at a rate of 1 pt. of product per acre; (3) enriched yeast (Sigma Aldrich product no. 07533) applied in-furrow at a rate of 1 qt. of product per acre; (4) enriched yeast (Sigma Aldrich product no. 07533) applied as a seed treatment at a rate of 8 oz. of product per 100 lbs. of seed; (5) enriched yeast (Sigma Aldrich product no. 07533) applied foliar at a rate of 1 pt. of product per acre; and (6) enriched yeast (Sigma Aldrich product no. 07533) applied foliar at a rate of 1 qt. of product per acre.

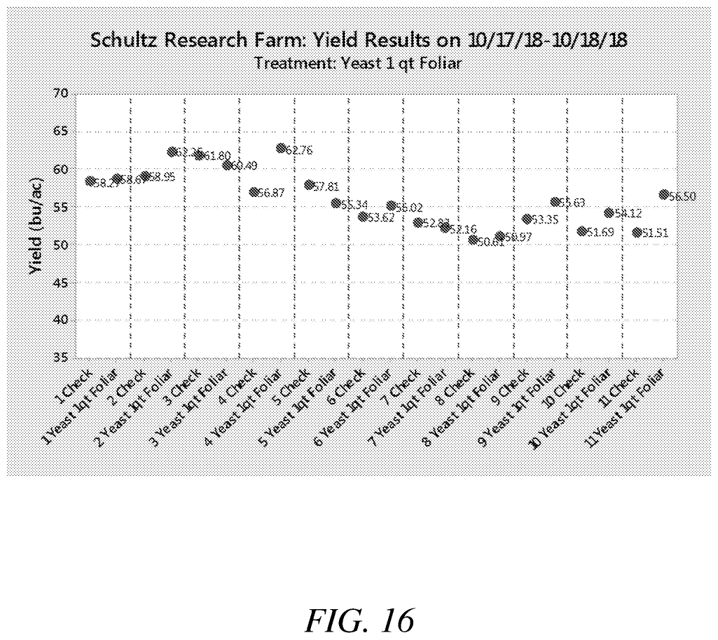

FIG. 16 is a graphical view of showing soybean yield in (bu/ac) in trials where the treatment composition was applied foliar, according to one or more embodiments of the present disclosure. The applications included foliar applications to soy. The treatments included 11 checks and 11 treatments applied foliar at a rate of 1 qt. of product per acre. The average yield results were as follows: yield for check was 55.2099 bu/ac and yield for treatments of yeast applied foliar at a rate of 1 qt. of product per acre was 56.7188 bu/ac.

An indoor greenhouse trial on yeast extract (enriched with vitamins) on corn was also conducted. The yeast extract included product number 07533. The application rates were increased, considering the benefit was still increasing at the highest rate on soy. This trial evaluated the interaction of the benefit of the yeast extract with chitosan. The trial was planted in late 2017 and is around the V4 plant stage. The treatments included (1) a check, (2) yeast extract at 8 oz. cwt.; (3) yeast extract at 12 oz. cwt.; (4) yeast extract at 16 oz. cwt.; (5) yeast at 8 oz. cwt and about 7 g of chitosan; and (6) yeast extract at 16 oz. cwt. and about 7 g of chitosan. All treatments were positive.

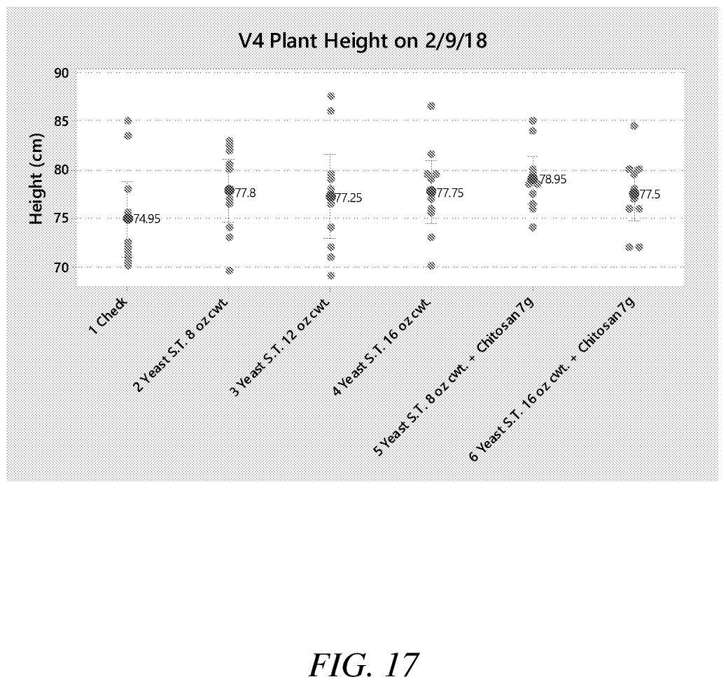

FIG. 17 is a graphical view of V4 plant heat for each of the treatments applied to corn, according to one or more embodiments of the present disclosure.

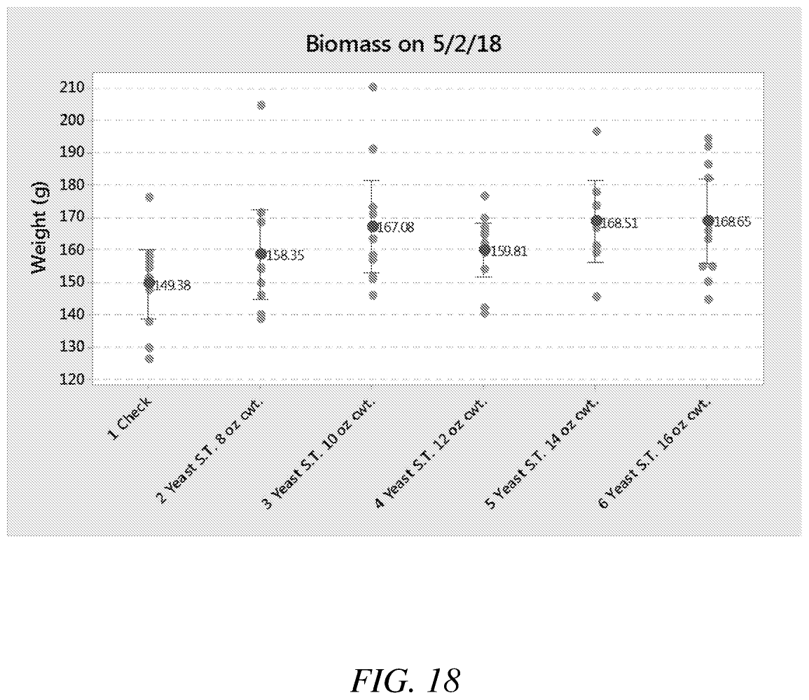

FIG. 18 is a graphical view of corn biomass in trials where the treatment composition was applied as a seed treatment, according to one or more embodiments of the present disclosure. The treatments included (1) a check; (2) yeast extract (Sigma Aldrich product number 07533) applied at a rate of 8 oz. of product per 100 lbs. of seed; (3) yeast extract (Sigma Aldrich product number 07533) applied at a rate of 10 oz. of product per 100 lbs. of seed; (4) yeast extract (Sigma Aldrich product number 07533) applied at a rate of 12 oz. of product per 100 lbs. of seed; (5) yeast extract (Sigma Aldrich product number 07533) applied at a rate of 14 oz. of product per 100 lbs. of seed; and (6) yeast extract (Sigma Aldrich product number 07533) applied at a rate of 16 oz. of product per 100 lbs. of seed.

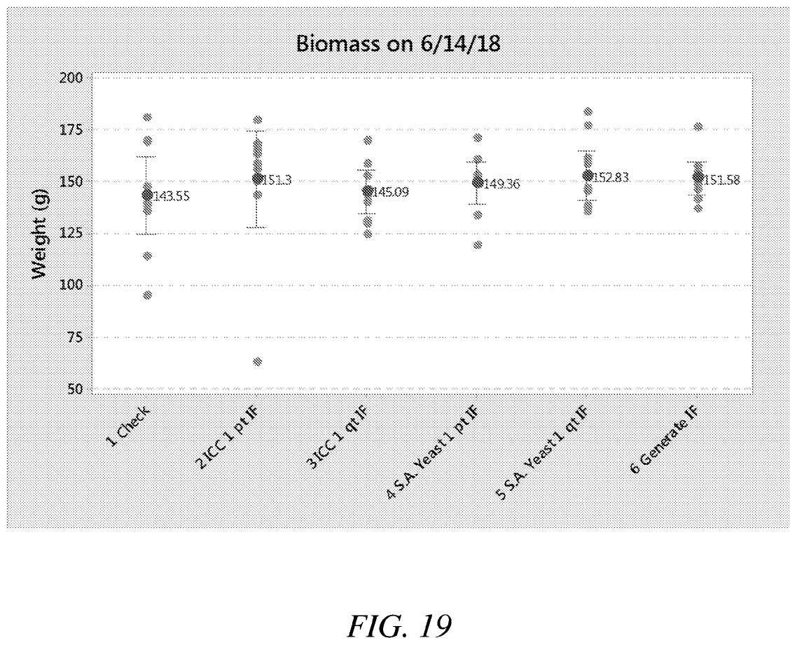

FIG. 19 is a graphical view of corn biomass following in-furrow treatment applications, according to one or more embodiments of the present disclosure. All treatments were applied in-furrow. The treatments included (1) check; (2) ICC yeast extract applied at a rate of 1 pt. of product per acre; (3) ICC yeast extract applied at a rate of 1 qt. of product per acre; (4) yeast extract (Sigma Aldrich product no. 07533) applied at a rate of 1 pt. of product per acre; (5) yeast extract (Sigma Aldrich product no. 07533) applied at rate of 1 qt. of product per acre; and (6) a product Generate applied in-furrow.

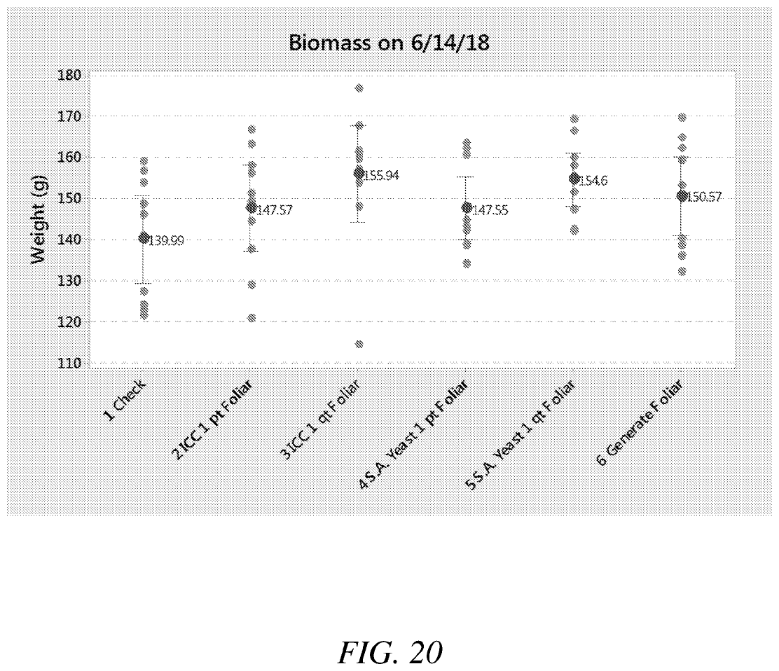

FIG. 20 is a graphical view of corn biomass following foliar treatment applications, according to one or more embodiments of the present disclosure. All treatments were applied foliar. The treatments included (1) check; (2) ICC yeast extract applied at a rate of 1 pt of product per acre; (3) ICC yeast extract applied at a rate of 1 qt of product per acre; (4) yeast extract (Sigma Aldrich product no. 07533) applied at a rate of 1 pt. of product per acre; (5) yeast extract (Sigma Aldrich product no. 07533) applied at a rate of 1 qt. of product per acre; and (6) a product Generate applied foliar.

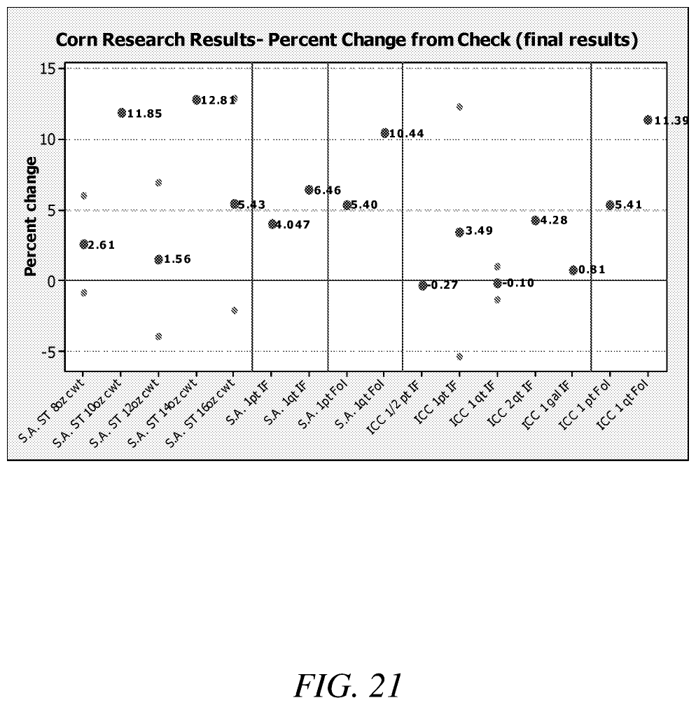

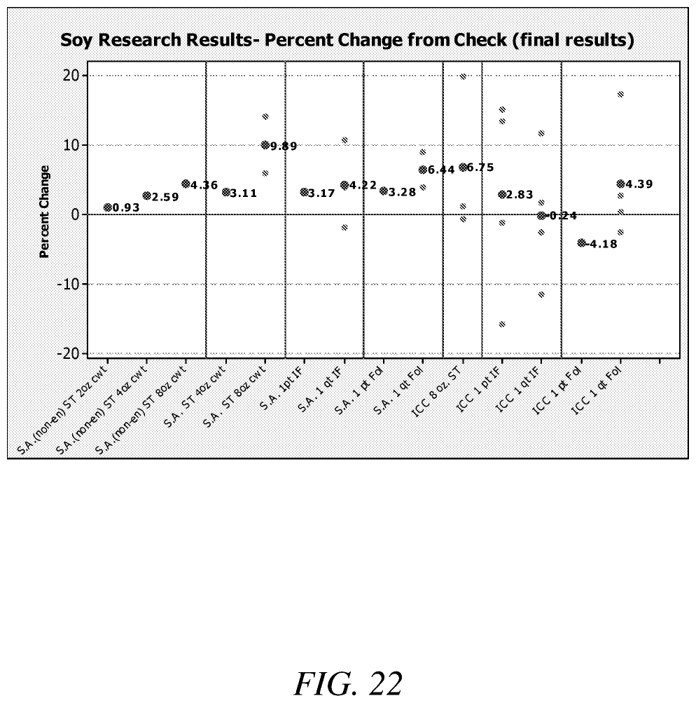

FIGS. 21-22 are graphical views showing the percent change from check for corn (FIG. 21) and soy (FIG. 22) for seed treatments, in-furrow, and foliar applications, according to one or more embodiments of the present disclosure.

In summary, yeast extract was demonstrated to be beneficial to plant performance. As shown in FIG. 14, two different types of yeast extract were used and, as levels increased for each source, the soybean seed weight per pot increased. FIG. 15 shows that all three application styles: seed treatment, in-furrow, and foliar were beneficial to the plant performance and, as the rate of yeast extract increased, the soybean seed weight per pot also increased. Yeast extract was tested on a realistic level, by replicating it 11 times on a soybean research farm. Yeast extract, applied at 1 qt foliar, was able to increase the soybean yield on 8 of the 11 replications, and had an overall greater average yield than the check, as shown in FIG. 16.

Yeast extract was also beneficial in the corn greenhouse trials as shown by an increase in plant height and biomass. FIG. 17 shows that all rates of seed treatment yeast extract were able to increase V4 corn plant height. Yeast extract had a linear increase as the rate of seed treatment increased on corn, measured through plant biomass in FIG. 18. Yeast extract was also shown to be beneficial as an in-furrow and foliar product on corn, based on increases in plant biomass in FIGS. 19 and 20.

FIGS. 21 and 22 are overviews of all the trials conducted on yeast extract on corn and soy. The average percent change from check is shown with a larger-diameter data point. FIG. 21 shows yeast extract had a positive response on corn when applied as a seed treatment, in-furrow, and foliar. Most promising was the seed treatment and foliar applications on corn. When looking at the overview of soybean response in FIG. 22, all three forms of application; seed treatment, in-furrow, and foliar, demonstrated potential for beneficial soybean responses. Due to the widespread positive increases in plant performance in varying crops, application styles and usage rates, yeast extract would be a strong commercial agriculture application to maximize plant growth and yield.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of applying a treatment composition, comprising:
applying a treatment composition to seeds, soil, or a plant, wherein the treatment composition comprises yeast extract, wherein the yeast extract includes yeast cells without or substantially without cell walls.

2. The method of claim 1, wherein the treatment composition is applied to soil, wherein the applying includes one or more of broadcasting on soil, tilling in soil, applying side-dress, applying in-furrow, and applying in proximity to planted seeds.

3. The method of claim 2, wherein the application rate of the treatment composition is about 1 qt. of the treatment composition per acre or less.

4. The method of claim 1, wherein the treatment composition is applied to the plant, wherein the applying includes applying to foliar.

5. The method of claim 4, wherein the application rate of the treatment composition is about 1 qt. of the treatment composition per acre or less.

6. The method of claim 1, wherein the treatment composition is applied to seeds, wherein the applying includes one or more of spraying seeds with the treatment composition, pouring the treatment composition over seeds, passing the seeds through a volume of the treatment composition.

7. The method of claim 6, wherein the application rate of the treatment composition is about 16 oz. of the treatment composition per 100 lbs. of seed or less.

8. The method of claim 6, wherein the applying further includes agitating seeds after the treatment composition has been applied to the seeds.

9. The method of claim 1, wherein the yeast extract is derived from yeast cells belonging to one or more of the following genera: Metschnikowia, Aureobasidiuim, Cryptococcus, Candida, Hanseniaspora, Pichia, Sporobolomyces, Sporidiobolus, Bulgaria, Cystofilobasidium, Malassezia, Saccharomyces, Rhodotorula, Mrakia, Glaciozyma, Starmerella, Wickerhamomyces, Tilletiopsis, Galactomyces, Issatchenkia, Kluyveromyces, Bensingtonia, Derxomyces, Hannaella, Dioszegia, Debaryomyces, Torulaspora, Trichosporon, Arthroderma, Hortaea, Rhodosporidium, Dipodascopsis, Kazachstania, and Kockovaella.

10. The method of claim 1, where in the yeast extract is derived from yeast cells belonging to one or more of the following species: Saccharomyces cerevisiae, Saccharomyces chevaiieri, Saccharomyces delbrueckii, Saccharomyces exiguus, Saccharomyces fermentati, Saccharomyces logos, Saccharomyces mellis, Saccharomyces microellipsoides, Saccharomyces oviformis, Saccharomyces rosei, Saccharomyces rouxii, Saccharomyces sake, Saccharomyces uvarum Beij'er, Saccharomyces willianus, Saccharomyces sp., Saccharomyces ludwigii, Saccharomyces sinenses, Saccharomyces bailii, Saccharomyces carlsbergensis, Schizosaccharomyces octosporus, Schizosaccharomyces pombe, Sporobolomyces roseus, Sporobolomyces salmonicolor, Torulopsis Candida, Torulopsis famta, Torulopsis globosa, Torulopsis inconspicua, Trichosporon behrendoo, Trichosporon capitatum, Trichosporon cutaneum, Kluyveromyces fragilis, Wickerhamia fluoresens, Ashbya gossypii, Blastomyces dermatitidis, Candida albicans, Candida arborea, Candida guillermondii, Candida Krusei, Candida lambxca, Candida lipolytica, Candida par akrusei, Candida par apsilosis, Candida par apsilosis, Candida pseudotropicalis, Candida pulcherrima, Candida robusta, Candida rugousa, Candida utilis, Citeromyces matritensis, Crebrothecium ashbyii, Cryptococcus laurentii, Cryptococcus neoformans, Debaryomyces hansenii, Debaryomyces kloeckeri, Endomycopsis fibuligera, Eremothecium ashbyii, Geotrichum candidum, Geotrichum ludwigii, Geotrichum robustum, Geotrichum suaveolens, Hansenula anomala, Hansenula arabitolgens, Hansenula jadinii, Hansenula saturnus, Hansenula schneggii, Hansenula subpelliculosa, Kloeckera apiculata, Lipomyces starkeyi, Pichia far inosa, Pichia membranaefaciens, Rhodosporidium toruloides, Rhodotorula aurantiaca, Rhodotorula glutinis, Rhodotorula minuta, Rhodotorula rubar, and Rhodotorula sinesis.

11. The method of claim 1, wherein the treatment composition further comprises vitamins.

12. The method of claim 1, wherein the treatment composition further comprises one or more mineral chelated compounds.

13. The method of claim 12, wherein the mineral chelated compound includes one or more of a cobalt chelated compound, a scandium chelated compound, a selenium chelated compound, a titanium chelated compound, a vanadium chelated compound, a manganese chelated compound, an iron chelated compound, a nickel chelated compound, a copper chelated compound, and a zinc chelated compound.

14. The method of claim 12, wherein a mineral of the mineral chelated compound includes one or more of cobalt, scandium, selenium, titanium, vanadium, manganese, iron, nickel, copper, and zinc.

15. The method of claim 12, wherein a chelate of the mineral chelated compound includes one or more of lactate, ethylene diamine, ethylenediamine tetraacetate (EDTA), propionate, butyrate, and acetate.

16. The method of claim 1, further comprising one or more mineral salt compounds.

17. The method of claim 16, wherein a mineral of the mineral salt compound includes one or more of cobalt, scandium, selenium, titanium, vanadium, manganese, iron, nickel, copper, zinc, aluminum, tin, and chromium.

18. The method of claim 16, wherein a salt anion of the mineral salt compound includes one or more of bromide, chloride, fluoride, carbonate, hydroxide, nitrate, oxide, phosphate, sulfate, formate, acetate, propionate, butyrate, oxalate, citrate, malate, lactate, or tartrate.

19. The method of claim 1, wherein the treatment composition improves one or more of plant emergence, crop yield, stand count, leaf area, root size, plant height, plant health, and plant resistance to disease and drought.

20. The method of claim 1, wherein the treatment composition is combined with one or more of a carrier, a solid carrier, a fiber, an enzyme, chitosan, a pesticide, an insecticide, a fungicide, a herbicide, and a chelate or inorganic salt.
